(19) United States
(12) Patent Application Publication
(10) Pub. No.: US 2007/0060204 A1
(43) Pub. Date: Mar. 15, 2007

(54) Folder type cellular phone foldable backward with large display

(76) Inventor: Jae Ho Lee, Allendale, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/390,497

(22) Filed: Mar. 27, 2006

(30) Foreign Application Priority Data
Mar. 28, 2005 (KR) 10-2005-0025292

(51) Int. Cl. H04B 1/38; H04M 1/00

(52) U.S. Cl. 455/566; 455/575.3

(57) ABSTRACT

Disclosed herein is a folder type cellular phone foldable backward with a large display, which is folded in the opposite direction to a folded direction of conventional cellular phones, in order to prevent that a phone body covers the display. The folder type cellular phone includes: a phone body; a display; a large display larger than the phone body and having a body accommodating space formed on the rear surface thereof in a form corresponding to a form of the phone body; and rotating means for connecting the upper portion of the phone body with the lower portion of the large display and rotating the phone body toward the rear surface of the large display.

### CROSS-REFERENCE TO RELATED APPLICATION

This application claims the priority of Korean Patent Application No. 10-2005-0025292 filed Mar. 28, 2005, the disclosure of which is incorporated herein by reference in its entirety for all purposes.

### BACKGROUND OF THE INVENTION

1. Field of the Invention

The present invention relates to a folder type cellular phone foldable backward with a display larger than a phone body, and more particularly, to a folder type cellular phone folded backward with large display, which includes a large display having a body accommodating space formed in correspondence with a form of the phone body, the phone body connected with the large display, and rotating means for rotating the phone body toward the rear surface of the large display.

In the present invention, a large display 20 means a screen larger than a cellular phone body. As the use of a moving picture service, a Global Positioning System (G.P.S) service, and a Digital Multimedia Broadcasting (D.M.B) service increase, the size of the cellular phone also increases. Furthermore, the large display may have a separate power supply device since it consumes a great deal of energy.

In the present invention, the cellular phone body 10 means a part having input means such as buttons of a folder type cellular phone except an output display and rotating and connecting means.

2. Background Art

In general, a cellular phone includes a body part having buttons, and a display part which is output means. According to coupling forms between the body part and the display part, the cellular phone is classified into a folder type and a slide type.

Recently, folder type cellular phones (forward folded type) are used the most in Korea. In the folder type cellular phone, the phone body part and the display part are coupled with each other through rotating means, and the folder type cellular phone is kept in custody by folding it when it is not used. When the folder type cellular phone is unfolded, the front surface of the display part and the front surface of the body part having buttons which are input means are exposed at the same time, but when the folder type cellular phone is folded, the front surface of the display part and the front surface of the body part are faced or in contact with each other.

The folder type cellular phone is better than the slide type cellular phone, and has advantages in compactness, prevention of unexpected pressing due to incidental button contact, and improvement of durability of the cellular phone.

Generally, the cellular phone is used for conducting voice call or message transmission. Therefore, in this case, input (number, message) and screen output (number, message) by buttons, voice input through a microphone, and a partner's voice output through a speaker are achieved. At this time, the input by a user and the screen output by the user's input are simultaneously accomplished, or there is little time interval between input time and output time.

However, recently, the cellular phone is widely used as a receiver for moving picture service, G.P.S service, and D.M.B service. In this case, a time period for inputting a process to connect with one of the above services using buttons is short, but since the cellular phone continuously receives input of the service contents from a service transmission center after connection with the wanted service, the user watches the display part for a long time. Moreover, after input by the buttons, there is no need that the front surface of the body part is located at a place where the user can easily touch, and so, the body part occupies unnecessary space. In other words, folding is needed during use of the cellular phone.

Hereinafter, problems caused when the conventional folder type cellular phone (forward folded type) is used as a receiver for moving picture service, G.P.S service, and D.M.B service will be described.

The user unfolds the folder type cellular phone to watch the display providing a wanted service. In this case, as described above, the body part occupies the unnecessary space after the short-term input through buttons, so the conventional folder type cellular phone has a disadvantage in that compactness of the cellular phone is deteriorated and it is not easy to control the location of the display to a horizontal plane.

Additionally, the conventional folder type cellular phone has another disadvantage in that the body part covers the display when the user folds the cellular phone after the short-term button manipulation to watch the wanted service on the display.

### SUMMARY OF THE INVENTION

Accordingly, the present invention has been made to solve the above problems occurring in the prior art, and it is an object of the present invention to provide a folder type cellular phone foldable backward with a large display, which includes a phone body rotated and folded in the opposite direction to a folded direction of the conventional cellular phone when a user watches a wanted service on the display after button manipulation, and a body accommodating space for receiving the folded phone body, thereby reducing an occupation space of the phone body when the cellular phone is folded, controlling a position of the large display, and preventing covering of the display by the folded phone body.

It is another object of the present invention to provide a folder type cellular phone foldable backward with a large display, which selectively includes a button protective cover, thereby protecting buttons, promoting durability of the cellular phone, and controlling inclination of the large display.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a folder type cellular phone foldable backward with a large display seen from the front side of the large display according to the present invention;

FIG. 2 is a perspective view showing the folder type cellular phone foldable backward with the large display of FIG. 1 seen from the rear side of the large display;

FIG. 3 is an enlarged view of rotating means of FIG. 2;

FIG. 4 is a perspective view showing the folded cellular phone seen from the rear side of the large display;

FIG. 5 is a perspective view of the folder type cellular phone foldable backward with the large display having a button protective cover according to the present invention; and

FIG. 6 is a side view of the folder type cellular phone foldable backward with the large display unfolded at an angle of 240°.

### DETAILED DESCRIPTION OF THE PREFERRED EMBODIMENT

Reference will be now made in detail to the preferred embodiment of the present invention with reference to the attached drawings.

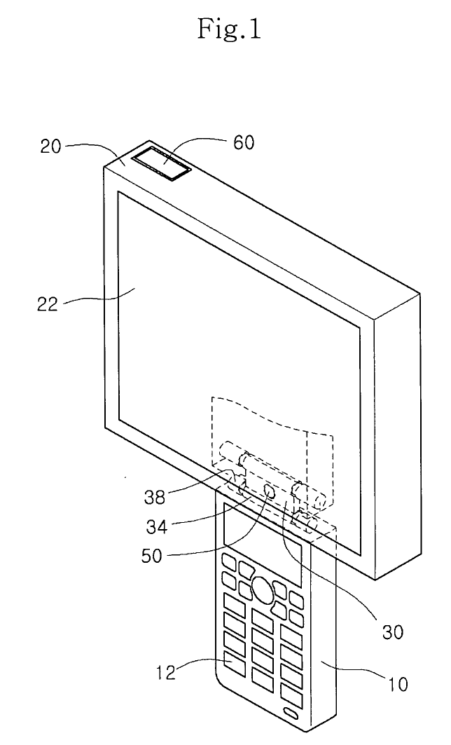

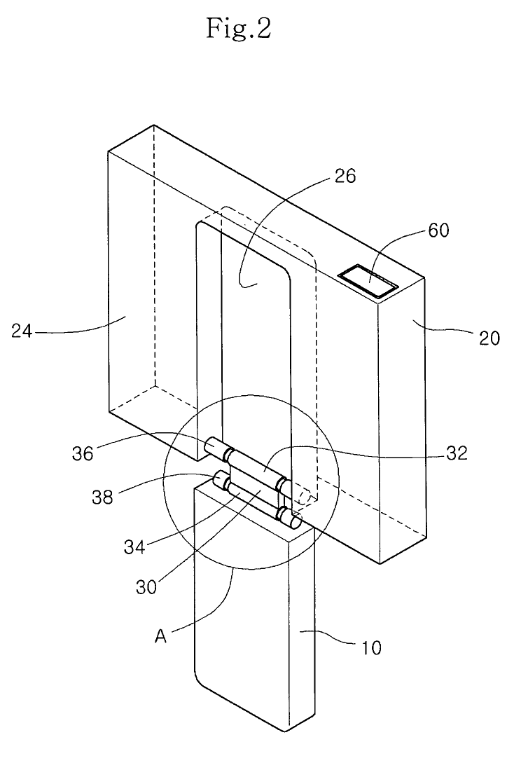

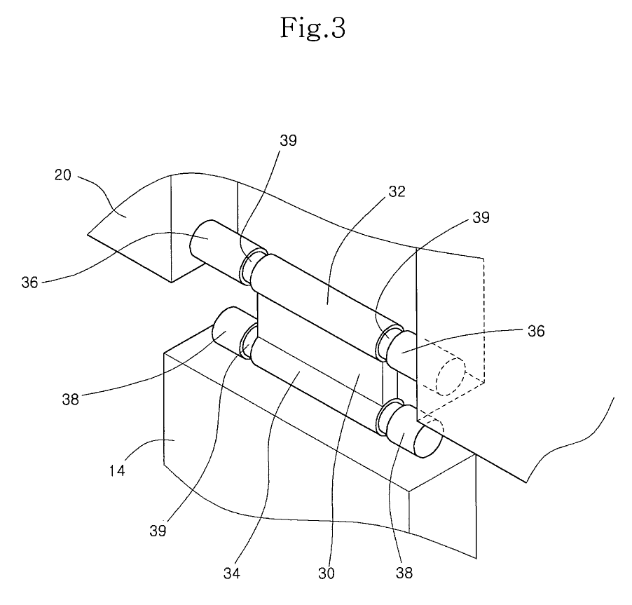

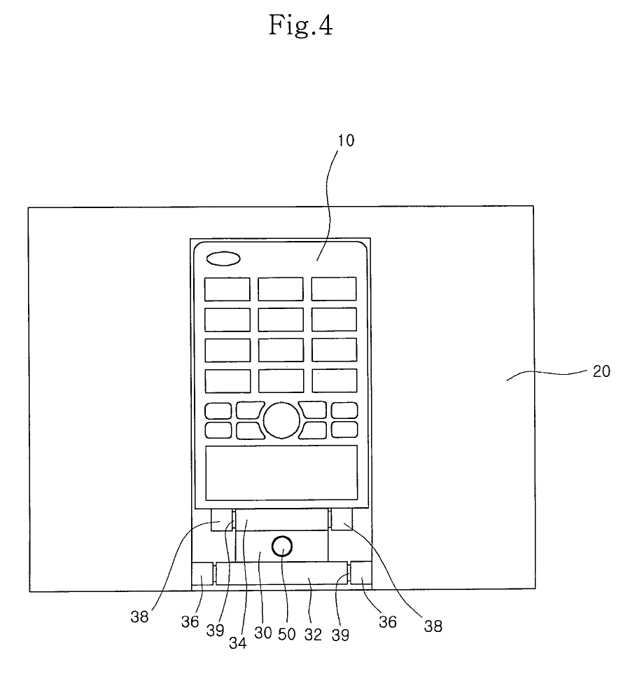

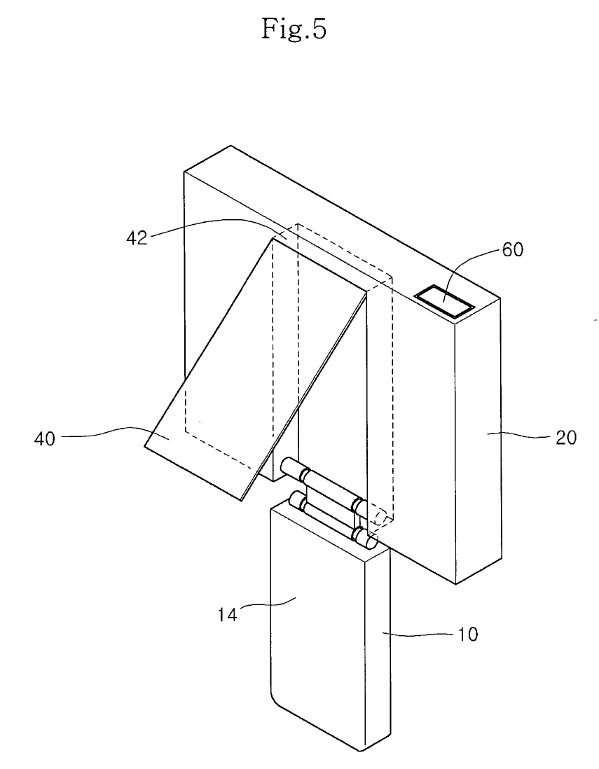

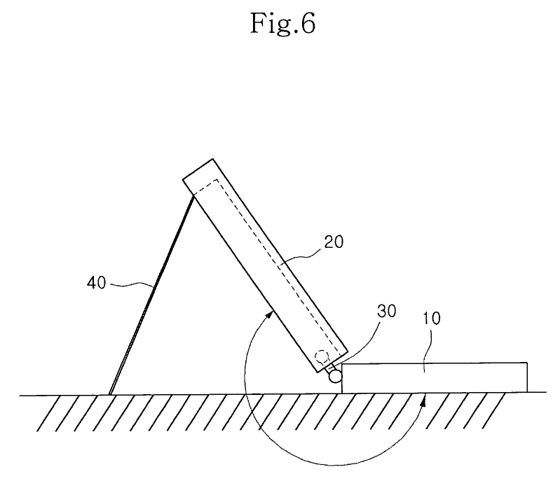

FIG. 1 is a perspective view showing a folder type cellular phone foldable backward with a large display seen from the front side of the large display according to the present invention, FIG. 2 is a perspective view showing the folder type cellular phone foldable backward with the large display of FIG. 1 seen from the rear side of the large display, FIG. 3 is an enlarged view of rotating means of FIG. 2, FIG. 4 is a perspective view showing the folded cellular phone seen from the rear side of the large display, FIG. 5 is a perspective view of the folder type cellular phone foldable backward with the large display having a button protective cover according to the present invention, and FIG. 6 is a side view of the folder type cellular phone foldable backward with the large display unfolded at an angle of 240°.

According to the present invention, a folder type cellular phone foldable backward with a large display, which includes a phone body 10 and a display, further includes: a large display 20 larger than the phone body 10 and having a body accommodating space 26 formed on the rear surface 24 thereof in a form corresponding to a form of the phone body 10; and rotating means for rotating the phone body 10 toward the rear surface 24 of the large display 20 in a state where the phone body 10 is coupled to the lower portion of the large display 20. Furthermore, the cellular phone may selectively include a button protective cover 40 for covering a side 12 of the phone body 10 having buttons when the phone body 10 is contained in the body accommodating space 26.

FIG. 1 is a perspective view showing the folder type cellular phone foldable backward with the large display seen from the front side of the large display according to the present invention. In the present invention, the large display means output means of the cellular phone used for using moving picture service, G.P.S (Global Positioning System) service, and D.M.B (Digital Multimedia Broadcasting) service, or as the general use of the cellular phone. It is preferable that the large display 20 has a ratio of the width to the length is 4:3, but the large display 20 may have another ratio. The large display 20 can be an indication element such as LCD or organic EL, and have a size of 2.5″˜12″ or more.

Considering that the large display 20 consumes a great deal of energy, the large display 20 may have a separate power supply device which operates independently from a power supply device of the phone body. For instance, as shown in FIG. 1, the large display 20 may have a rechargeable battery 60 embedded in the upper end thereof and being independent from a battery of the phone body. Moreover, the large display 20 may have a high quality speaker such as 5.1 channel as sound output means so as to obtain sound output of high quality.

FIG. 2 is a perspective view showing the folder type cellular phone foldable backward with the large display of FIG. 1 seen from the rear side of the large display. As shown in FIG. 2, the large display 20 includes the front surface 22 for showing display and the rear surface 24 opposed to the front surface 22. In the present invention, it is preferable that the large display 20 is thicker than the phone body 10. The body accommodating space 24 is formed on the rear surface 24 of the large display, and has a form and a depth corresponding to a form and a depth of the phone body 10 so that the phone body 10 is contained in the rear surface 24 of the large display when the cellular phone is folded. In the case where the thickness of the large display 20 is closely similar to the thickness of the phone body 10 or the large display 20 cannot have the phone containing space corresponding to the thickness of the phone body 10, the body accommodating space 24 may be formed shallowly in such a way as to contain only a predetermined depth of the entire depth of the phone body 10 from the rear surface 14 of the phone body 10.

FIG. 3 is an enlarged view of rotating means of FIG. 2. As shown in FIG. 3, the rotating means includes a connection plate 30, a first cylinder 32, a second cylinder 34, third cylinders 36, fourth cylinders 38, and a connection rod 39. The first cylinder 32 located on the top of the connection plate 30 is connected with the two third cylinders 36 supported at both dies of the body accommodating space 26 through the medium of the connection rod 39. The fourth cylinders 38 and the third cylinder 36 supported on the top of the phone body 10 are connected with each other in the same way as the above. The length of the connection rod 39 can be adjusted properly.

If the cellular phone is excessively unfolded, for instance more than 300°, the front surface of the connection plate 30 is in contact with a horizontal edge of the lower end of the body accommodating space 26, and the top of the front surface of the phone body 10 is in contact with the lower end edge of the front surface of the large display 20. Thereby, when a user tries to fold the cellular phone forward, a limit of rotational movement is set. It is preferable that the rotating means restricts the movement limit in such a way that the phone body 10 rotates within a range of 0°˜270° (0° indicates a state where the phone body is folded completely backward) in consideration of easiness in button manipulation.

In FIG. 3, the rotating means includes the connection plate 30, the first cylinder 32, the second cylinder 34, the third cylinders 36, the fourth cylinders 38, and the connection rod 39, but any means capable of connecting the phone body 10 with the large display 20 in such a way as to fold the large display 20 and rotating them can be used. Therefore, not only the rotating means shown in FIG. 3 but also various rotating means of folder type cellular phones which have been commercialized and widely known in Korea are included in the range of the rotating means of the present invention.

A digital camera 50 is located at the connection plate 30. However, the digital camera 50 can be located on the front surface of the second cylinder 34.

FIG. 4 is a perspective view showing the folded cellular phone seen from the rear side of the large display. As shown in FIG. 4, when the large display 20 is completely folded, the phone body 10 is contained in the body accommodating space 26.

FIG. 5 is a perspective view of the folder type cellular phone foldable backward with the large display having a button protective cover according to the present invention, and FIG. 6 is a side view of the folder type cellular phone foldable backward with the large display unfolded at an angle of 240°.

As shown in FIG. 5, the button protective cover 40 is supported on the rear surface of the large display 20, and has a width and a form corresponding to a width and a form of an opened surface of the body accommodating space 26 so as to cover the opened surface of the body accommodating space 26. As shown in FIG. 5, the location of a supporting part 42 of the button protective cover 40 is located at an edge of the body accommodating space 26, but the location of the supporting part 42 is not restricted to it. The supporting part 42 can be located at any place of the rear surface 24 of the large display 20 if it can rotate and support the button protective cover 40.

Referring to FIG. 6, an angle adjustment of the button protective cover 40 will be described. The button protective cover 40 serves to freely adjust an angle of the large display 20 to the horizontal plane. Therefore, the button protective cover 40 may have a reading stand and inclination-adjusting means. For instance, an inclination-adjusting bar is supported on the rear surface 24 of the large display 20, and concave portions or convex portions are formed at several positions of the surface of the button protective cover 40 directing to the body receiving space 26, so that the inclination of the large display 20 can be adjusted and kept when the inclination-adjusting bar is caught to one of the concave portions or the convex portions. Not shown in FIG. 6, inclination-adjusting means used for the reading stand has been widely known to those skilled in the art and can be easily applied to the present invention, and so can be selectively included in the concept of the button protective cover 40 of the present invention. FIG. 6 shows a used state of the folder type cellular phone foldable backward with the large display on which the button protective cover is mounted and opened at an angle of about 240°.

The operation of the folder type cellular phone foldable backward with the large display according to the present invention will be described.

The body accommodating space 24 of the large display 20 according to the present invention provides a space for containing the phone body 10 after the phone body 10 rotates toward the rear surface 24 of the large display 20 through the rotation by the rotating means. Therefore, if necessary, the cellular phone according to the present invention can remove an unnecessary space occupied by the phone body 10 by folding the phone body 10. Since the phone body 10 is contained in the rear surface 24 of the large display 20, the angle of the large display 20 can be easily adjusted to the horizontal plane by using additional devices without any structural hindrance by the phone body.

Furthermore, differently from the conventional cellular phones, since the rotating means according to the present invention is configured in such a way that the phone body 10 is rotated toward the rear surface 24 of the large display 20 and the rear surface 14 of the phone body 10 is first contained in the body accommodating space (backward folded type), the cellular phone can be folded without covering the large display while the user watches a screen.

The button protective cover 40 serves to promote durability of buttons and prevent unintended input or button pressing by protecting the buttons from the outside when the phone body 10 is contained in the body accommodating space 26 of the large display 20. Moreover, the button protective cover 40 serves to easily adjust the angle of the large display to the horizontal plane when the button protective button 40 is opened, for example, at an angle of 45°˜60°, to the rear surface of the large display 20 and an edge 44 opposed to the supporting part 42 is grounded on the horizontal plane.

While the present invention has been described with reference to the particular illustrative embodiments, it is to be appreciated that those skilled in the art can change or modify the embodiments without departing from the scope and spirit of the present invention. For instance, the rotating means can be made of a soft material integrally with the large display 20 and the phone body 10 or another body accommodating space which has a form not nearly similar with the form of the phone body 10 but provides the same function can be formed on the rear surface of the large display. Also in the above case, the inclination-adjusting means can be easily mounted on the button protective cover 40.

As described above, in the cellular phone foldable backward with the large display, the phone body 10 s contained in the rear surface of the large display 20 when the cellular phone is folded. Therefore, when button input is needed no more while the user watches the moving picture service or others on the screen, unnecessary space occupied by the phone body can be removed by folding the cellular phone. Furthermore, the angle of the large display 20 to the horizontal plane can be easily adjusted without any structural hindrance by the phone body by using additional device. Therefore, the present invention can solve various problems of space, durability, angle adjustment of the screen, and so on caused when the conventional folder type (forward folded type) cellular phone provides the moving picture service, G.P.S service, or D.M.B service in a state where the cellular phone is unfolded.

The phone body 10 according to the present invention is rotated and folded in the opposite direction to the folded direction of the conventional cellular phone, and contained in the body accommodating space 26. Therefore, the present invention can be folded not only when the cellular phone is not used but also when the user continuously watches the screen without button manipulation. So, the present invention can solve the problem that the phone body covers the screen when the cellular phone is folded while the moving picture service, G.P.S service, or D.M.B service is provided to the cellular phone.

The button protective cover 40 according to the present invention can promote durability by protecting the buttons when the phone body 10 is contained in the large display 20, and allow the user to easily adjust the angle of the large display 20 to the horizontal plane, thereby promoting convenience in watching the screen when the moving picture service, G.P.S service, or D.M.B service is provided through the cellular phone.

In other words, the cellular phone foldable backward with the large display according to the present invention can solve problems of inefficiency in space, deterioration of durability, and screen covering caused when the conventional folder type (forward folded type) is used as a receiver for the moving picture service, G.P.S service, or D.M.B service, and promote convenience in watching the screen.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A folder type cellular phone foldable backward with a large display, which includes a phone body and a display, the folder type cellular phone comprising:
a large display unit larger than the phone body and having a body accommodating space formed on the rear surface thereof in a form corresponding to a form of the phone body; and
rotating means for connecting the upper portion of the phone body with the lower portion of the large display and rotating the phone body toward the rear surface of the large display.

2. The folder type cellular phone foldable backward with a large display according to claim 1, wherein the rotating means includes:
a first hollow cylinder;
a second hollow cylinder;
a connection plate located between the first cylinder and the second cylinder;
a pair of third hollow cylinders supported at the lower portions of both sides of the body receiving space;
a pair of fourth hollow cylinders supported at the upper portion of the phone body;
a connection rod supported by the third cylinders and passing through the first cylinder, and another connection rod supported by the fourth cylinders and passing through the second cylinder.

3. The folder type cellular phone foldable backward with a large display according to claim 1, further comprising a button protective cover supported on the rear surface of the large display and having a width and a form corresponding to a width and a form of an opened surface of the body accommodating space to cover the opened surface of the body accommodating space.

4. The folder type cellular phone foldable backward with a large display according to claim 1, wherein the rotating means rotates the phone body within a range of 0°˜270°.

5. The folder type cellular phone foldable backward with a large display according to claim 1, wherein a ratio of the width to the length of the large display is 4:3.
